(19) United States
(12) Patent Application Publication
(10) Pub. No.: US 2023/0007095 A1
(43) Pub. Date: Jan. 5, 2023

(54) METHODS AND APPARATUS FOR COMMUNICATING VECTOR DATA

(71) Applicants: HUAWEI TECHNOLOGIES CO., LTD., Shenzhen (CN); The Governing Council of the University of Toronto, Toronto (CA)

(72) Inventors: Tharindu ADIKARI, Toronto (CA); Stark C. DRAPER, Toronto (CA); Jason T S LAM, Markham (CA); Zhenhua HU, Toronto (CA)

(73) Assignees: HUAWEI TECHNOLOGIES CO., LTD., SHENZHEN (CN); The Governing Council of the University of Toronto, Toronto (CA)

(21) Appl. No.: 17/546,603

(22) Filed: Dec. 9, 2021

Related U.S. Application Data
(60) Provisional application No. 63/218,468, filed on Jul. 5, 2021.

(51) Int. Cl. H04L 67/00; G06N 20/00

(52) U.S. Cl. CPC H04L 67/34; G06N 20/00

(57) ABSTRACT

A method of communicating time correlated vector data within a network includes reading, by a transmitting node, a first vector data including a plurality of elements, selecting, by the transmitting node, a subset of elements of the plurality of elements based on a criteria and sending, by the transmitting node, the subset of elements to a receiving node. The receiving node receives the subset of elements and estimates a plurality of elements not included in the subset of elements based on a previously received subset of element based on a second vector data. The first vector data and the second vector data are part of a time series of vectors.

### CROSS-REFERENCE TO RELATED APPLICATIONS

This application claims the benefit of and priority to U.S. Provisional Application Ser. No. 63/218,468 filed Jul. 5, 2021, the entire contents of which are hereby incorporated by reference.

### TECHNICAL FIELD

The present disclosure pertains to the field of machine learning technologies, such as but not necessarily limited to the training of machine learning models, and in particular to a method and apparatus for distributed training machine learning models where large amounts of update vector data are communicated.

### BACKGROUND

Machine learning includes classes of computer implemented solutions and applications where computers are trained and optimized to perform tasks without being explicitly programmed to do so. Machine learning models may be advantageously used for problems where it may be challenging for a human to create the needed algorithms manually. Examples of applications that benefit from machine learning solutions include self-driving vehicles, language translation, fraud detection, weather forecasting, and others.

Machine learning models are trained using sample datasets selected for a particular application. For example, a character recognition model may be trained using a database of handwriting samples. Training data includes input data and information indicating the correct solution to the problem and is used to train and improve the machine learning model until it produces sufficiently accurate results. Training can involve very large datasets and require significant time to produce and train a sufficiently accurate model. Solutions involving decentralized, distributed computers and multiple computer nodes connected through computer networks have been used to decrease training time.

Decentralized optimization using multiple computer nodes, where update training vectors are exchanged among nodes, has become the norm for training machine learning models on large datasets. With the need to train bigger models on ever-growing datasets, scalability of communications between computer nodes has become a concern. A potential solution to growing dataset size is to increase the number of nodes, however communication amongst nodes can become a processing bottleneck and communication time can account for a significant portion of the overall machine learning model training time.

Therefore, there is a need for a method and apparatus for optimizing computer node updates by minimizing the size of update vector transmissions that obviates or mitigates one or more limitations of the prior art, for example by reducing communication overhead, while minimizing any impact on the convergence rate, and by reducing the amount of time and bandwidth required to communicate update vector transmissions.

This background information is provided to reveal information believed by the applicant to be of possible relevance to the present disclosure. No admission is necessarily intended, nor should be construed, that any of the preceding information constitutes prior art against the present disclosure.

### SUMMARY

An object of embodiments of the present disclosure is to provide a method and apparatus for compressing a time series of vector data for transmission in a network such as computer network. Embodiments use vector data where there is a temporal correlation between consecutive vector data of the time series. The time series of vector data may also refer to time correlated vector data.

Embodiments may be used in applications where machine learning models are trained using a plurality of computer nodes connected by a computer network, which may be configured in a master-worker arrangement where one master computer node coordinates update vector calculations performed by one or more worker computer nodes.

Embodiments may use error-feedback to improve compression rates without decreasing the convergence rate while training a machine learning model.

In accordance with embodiments of the present disclosure, there is provided a method of communicating vector data within a network. The method includes obtaining, by a transmitting node, a first vector data including a plurality of elements. Then, selecting, by the transmitting node, a subset of elements of the plurality of elements and sending, by the transmitting node, the subset of elements to a receiving node. Also, estimating, by the transmitting node, a plurality of elements not included in the subset of elements based on a previously transmitted subset of element based on a second vector data, and forming, by the transmitting node, a reconstructed vector data including the subset of elements and the estimated plurality of elements not included in the subset of elements.

In further embodiments, the estimating the plurality of elements not included in the subset of elements includes updating, when one of the subset of elements is transmitted, a predicted value of the one of the subset of elements and resetting a counter, and setting, when one of the subset of elements is not transmitted, one of the plurality of elements not included in the subset of elements with the predicted value, and incrementing the counter.

In further embodiments, the subset of elements is selected based on a criteria, and the criteria is an absolute value of each of the plurality of elements of the first vector data.

In further embodiments, the first vector data and the second vector data are update vectors as part of a machine learning model training process.

In further embodiments, the first vector data and the second vector data are part of a time series of vectors.

In further embodiments, the first vector data is obtained by combining an initial vector data with a weighted difference of the reconstructed vector data and the first vector data.

In accordance with embodiments of the present disclosure, there is provided a network node for transmitting vector data over a network connection. The network node includes a processor and a non-transient memory for storing instructions which when executed by the processor cause the network node to read a first vector data including a plurality of elements, select a subset of elements of the plurality of elements, and send the subset of elements to a receiving node. Also, to estimate a plurality of elements not included in the subset of elements based on a previously transmitted subset of elements based on a second vector data, and to form a reconstructed vector data including the subset of elements and the estimated plurality of elements not included in the subset of elements.

In further embodiments, the estimating the plurality of elements not included in the subset of elements includes updating, when one of the subset of elements is transmitted, a predicted value of the one of the subset of elements and resetting a counter, and setting, when one of the subset of elements is not transmitted, one of the plurality of elements not included in the subset of elements with the predicted value, and incrementing the counter.

In further embodiments, the subset of elements is selected based on a criteria, and the criteria is an absolute value of each of the plurality of elements of the first vector data.

In further embodiments, the first vector data and the second vector data are update vectors as part of a machine learning model training process.

In further embodiments, the first vector data is obtained by combining an initial vector data with a weighted difference of the reconstructed vector data and the first vector data.

In accordance with embodiments of the present disclosure, there is provided a network node for receiving vector data over a network connection. The network node includes a processor and a non-transient memory for storing instructions which when executed by the processor cause the network node to receive, from a transmitting node, a subset of elements of a first vector data. Furthermore, to estimate a plurality of elements not included in the subset of elements based on a previously received subset of element based on a second vector data, the first vector data and the second vector data being part of a time series of vectors, the subset of elements selected by the transmitting node. Also, to form a reconstructed vector data including the subset of elements and the estimated plurality of elements not included in the subset of elements.

In further embodiments, the estimating the plurality of elements not included in the subset of elements includes updating, when one of the subset of elements is received, a predicted value of the one of the subset of elements and clearing a counter, and setting, when one of the subset of elements is not received, one of the plurality of elements not included in the subset of elements with the predicted value, and incrementing the counter.

In further embodiments, the subset of elements is selected based on a criteria, and the criteria is an absolute value of each of the plurality of elements of the first vector data.

In further embodiments, the first vector data and the second vector data are update vectors as part of a machine learning model training process.

In further embodiments, the first vector data is obtained by combining an initial vector data with a weighted difference of the reconstructed vector data and the first vector data.

In accordance with embodiments of the present disclosure, there is provided a method of communicating vector data within a network. The method includes receiving, from a transmitting node, a subset of elements of a first vector data, and estimating a plurality of elements not included in the subset of elements based on a previously received subset of element based on a second vector data. The first vector data and the second vector data are part of a time series of vectors. The subset of elements selected by the transmitting node. Also, forming a reconstructed vector data including the subset of elements and the estimated plurality of elements not included in the subset of elements.

In further embodiments, the estimating the plurality of elements not included in the subset of elements includes updating, when one of the subset of elements is received, a predicted value of the one of the subset of elements and resetting a counter, and setting, when one of the subset of elements is not received, one of the plurality of elements not included in the subset of elements with the predicted value, and incrementing the counter.

In further embodiments, the subset of elements is selected based on a criteria, and the criteria is an absolute value of each of the plurality of elements of the first vector data.

In further embodiments, the first vector data and the second vector data are update vectors as part of a machine learning model training process.

In further embodiments, the first vector data is obtained by combining an initial vector data with a weighted difference of the reconstructed vector data and the first vector data.

In accordance with embodiments of the present disclosure, there is provided a method of communicating vector data within a network. The method includes obtaining, by a transmitting node, a first vector data including a plurality of elements, compressing, by the transmitting node, the first vector data to produce a compressed vector data, and sending, by the transmitting node, the compressed vector data to a receiving node. Also, estimating, by the transmitting node, a reconstructed vector from the compressed vector data and a second vector data, the first vector data and the second vector data being a part of a time correlated series of vector data, the second vector data being earlier in time than the first vector data. Furthermore, receiving, by the receiving node, from a transmitting node, the compressed vector data, and estimating, by the receiving node, the reconstructed vector.

Embodiments have been described above in conjunctions with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present disclosure will become apparent from the following detailed description, taken in combination with the appended drawings, in which:

FIG. 1 illustrates a network with a master computer node and a plurality of worker computer nodes in a star topology, according to an embodiment.

FIG. 2 illustrates a schematic diagram of a computing device that may be used to implement master computer node and worker computer nodes, according to embodiments.

FIG. 3 illustrates a method of training and utilizing a machine learning model and algorithm, according to an embodiment.

FIG. 4 illustrates a method of a worker node performing momentum, quantization, error-feedback, and encoding, and of a master performing decoding, and possible post-processing, according to an embodiment.

FIG. 5 illustrated the operation of an encoder, according to an embodiment.

FIG. 6 illustrates a method that may be used by predictors according to an embodiment.

FIG. 7 illustrates a generalized method for transmitting vector data between computer nodes, according to an embodiment.

It will be noted that throughout the appended drawings, like features are identified by like reference numerals.

### DETAILED DESCRIPTION

Embodiments of the present disclosure relate to methods, systems, and apparatus for compressing a time series of vector data for transmission in a computer network. Embodiments use time series vector data where there is a temporal correlation between consecutive vector data in the time series.

Embodiments may use error-feedback to improve compression rates without decreasing the convergence rate during a process to train a machine learning model.

Embodiments may be used in applications where machine learning models are trained using a plurality of computer nodes connected by a computer network, which may be configured in a master-worker arrangement where one master computer node coordinates update vector calculations performed by one or more worker computer nodes.

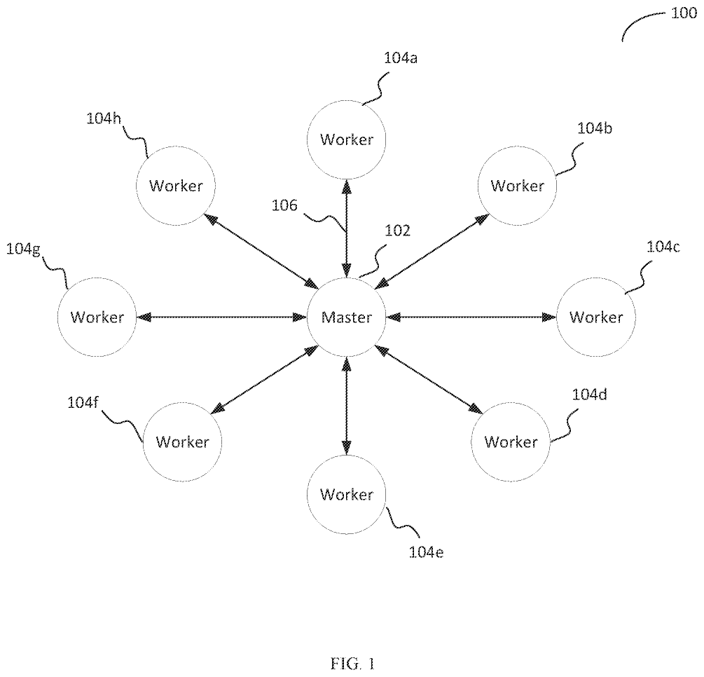

FIG. 1 illustrates a decentralized machine learning training architecture 100 using a master-worker model. A master 102 and eight workers (labelled 104a through 104h, which may be referred to collectively as 104 which may refer to workers individually or collectively) can be configured in a master-worker topology. Each worker 104 computes an update vector and sends it to the master 102. The master 102 computes the average of all update vectors received from the workers 104 and broadcasts the computed average back to workers 104. Each worker 104 then uses the average to update their learning model. These steps may be executed iteratively until a convergence criteria is met.

Though FIG. 1 illustrates a network in a star topology, embodiments may use any type of topology where there exist direct or indirect computer network connections 106 between master node 102 and worker nodes 104. Master node 102 and worker 104 nodes may be co-located or be distributed geographically. Computer network connections such as 106 may be implemented by a combination of hardware and software and include one or more networking technologies as are known in the art. Networking technologies include wired and wireless protocols such as WiFi (IEEE 802.11) and Ethernet protocols such as Gigabit Ethernet (GbE) and 10 Gigabit Ethernet (10GbE). Physical layer connections of connection 106 may use twisted pair cables or fibre optic cables as well as other physical layer connections as are known in the art. Physical layer connections of connection 106 may also include routers, switches, and bridges as required to make connections between master 102 and workers 104. Though FIG. 1 illustrates a star network topology, embodiments are not limited to any particular topology and may be implemented in networks with topologies such as ring, mesh, tree, bus, any others as are known in the art.

Stochastic gradient descent (SDG) is an algorithm for training a wide range of models in machine learning and for training artificial neural networks. SGD is an iterative method for optimizing an objective function with suitable smoothness properties and may be seen as a stochastic approximation of gradient descent optimization. SGD replaces the actual gradient calculated from the entire data set with an estimate gradient calculated from a randomly selected subset of the data. In high-dimensional optimization problems SGD reduces the computational burden and achieves faster iterations at the expense of a lower convergence rate. Other algorithms may also be used in embodiments such as the ADAM algorithm, an optimization algorithm for stochastic gradient descent for training deep learning models, which combines momentum ideas with adaptive step size.

A variation of the SGD algorithm is the momentum-SGD which is an iterative algorithm where all workers 104 collectively optimize a machine learning model while the master 102 facilitates synchronization. Each worker 104 computes an update vector and sends it to the master 102. The master 102 computes the average of all update vectors received from the workers 104 and broadcasts the average back to the workers 104. Each worker 104 then uses the average to update the learning model. These steps are executed iteratively until a convergence criteria is met. Successive update vectors transmitted between the master 102 and each worker 104 may be viewed as a plurality of time series of vector data, which in this embodiment may be iterative optimization parameters of the machine learning model. As used herein, “time series” refers to iterations of data occurring at consecutive times. In the cases, each iteration may be spaced equally apart in time, while in other cases, each iteration may be spaced at varying or random times from each other. In embodiments, each time iteration may depend on processing or communication time so that the time between iterations will vary within an expected range of values. In embodiments, each iteration occurs subsequent or previous to another while the time between samples places no limitations on embodiments. Examples of time series data includes update vectors used to train machine learning models, video processing, analysing stock market data, and processing astronomical and meteorological data.

Vector data transmitted from n workers 104 to the master 102 may be viewed as n separate time series of vector data. Vector data transmitted from master 102 to each of the n workers 104 may be viewed as another n separate time series of vector data. By using a momentum-SGD algorithm, the update vector smooths the stochastic gradient over the iterations for each time series of vector data. The momentum-SGD algorithm applies an exponentially weighted low-pass filter (LPF) to gradients across time iterations of the update vector which filters out high-frequency components and preserves low-frequency ones and reduces the variation in the resulting update vectors in consecutive iterations. Embodiments may also be optimized using different filter variations, such as filters that implement a combination of low-pass and band-pass characteristics. This causes each entry in the update vector to change slowly over the time iterations. Embodiments use this temporal correlation between elements of update vectors when compressing the update vectors transmitted between master 102 and workers 104.

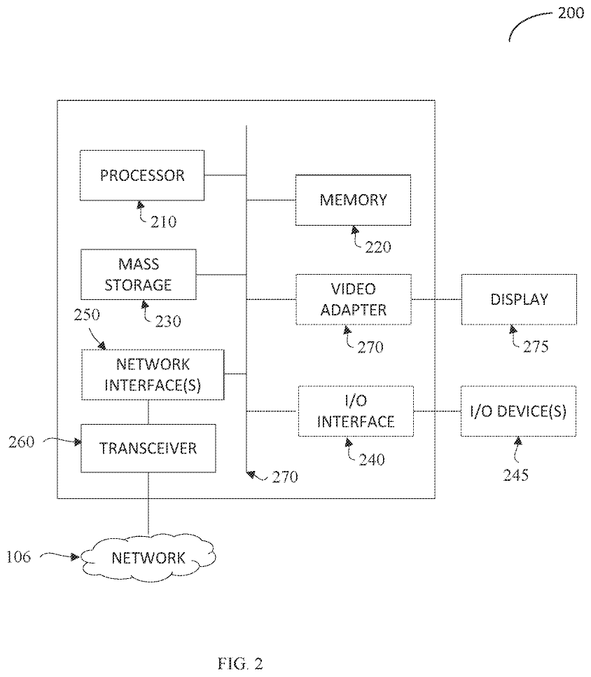

FIG. 2 is a schematic diagram of a computing device 200 that may be used to implement master computer node 102 and worker computer nodes 104 according to embodiments. Computing device 200 that may perform any or all of operations of the methods and features explicitly or implicitly described herein, according to different embodiments of the present disclosure. As shown, the device includes a processor 210, such as a Central Processing Unit (CPU) or specialized processors such as a Graphics Processing Unit (GPU), Vector Processing Unit (VPU), or other such processor unit, memory 220, non-transitory mass storage 230, I/O interface 240, network interface 250, and a transceiver 260, all of which are communicatively coupled via bi-directional bus 270. According to certain embodiments, any or all of the depicted elements may be utilized, or a subset of the elements. Further, the computing device 200 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 220 may include any type of non-transitory memory such as static random access memory (SRAM), dynamic random access memory (DRAM), synchronous DRAM (SDRAM), read-only memory (ROM), any combination of such, or the like. The mass storage element 230 may include any type of non-transitory storage device, such as a solid state drive, hard disk drive, a magnetic disk drive, an optical disk drive, USB drive, or any computer program product configured to store data and machine executable program code. According to certain embodiments, the memory 220 or mass storage 230 may have recorded thereon statements and instructions executable by the processor 210 for performing any of the aforementioned method operations described above.

Computing device 200 may also include one or more optional components and modules such as video adapter 270 coupled to a display 275 for providing output, and I/O interface 240 coupled to I/O devices 245 for providing input and output interfaces.

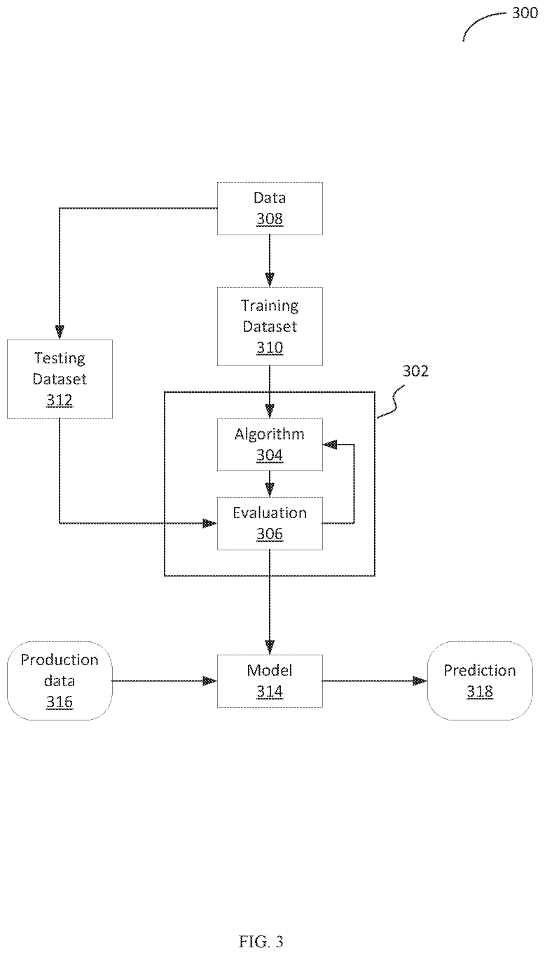

FIG. 3 illustrates a method of training and utilizing a machine learning model 314 and algorithm, according to an embodiment. Machine learning model 302 includes computer statements and instruction stored in memory 220 or mass storage 230 that may be read and executed by the processor 210 for performing methods described herein. Data 308 is collected from any number of sources and pre-processed to produce a training dataset 310. Pre-processing may include ensuring that data 308 is complete and in one or more common formats to be input into the machine learning model 302. Missing data may be added, ignored, or replaced with estimates, noisy data that results in outliers may be removed or smoothed with other data values. Inconsistent data and data that is in error may be corrected or compensated for. In the case that data 308 comes from a plurality of sources the data may have to be converted into a common format, have data from multiple sources combined, or have data divided or split as required for input to the machine learning model 320. The training dataset 310 may also be tagged to indicate to the machine learning model a type of data, a class of data, a subject of the data, the correctness of the data, etc. to allow the machine learning model 302 to “learn” from the training dataset 310.

In embodiments, the machine learning model 302 includes one or more machine learning algorithms that may be broadly classified as decision trees, support vector machines, regression, clustering, and other machine learning algorithms as is known in the art. Machine learning model 302 may also include an evaluation module 306 to evaluate the results of algorithm 304 which, in the case of supervised learning applications, may be done by comparing the tags of the training dataset 310 to the classification results produced by algorithm 304 in response to the training data 310. Training dataset 310 is used to tune and configure algorithm 304 which may include tuning parameters of the algorithm 304. Once tuned, machine learning model 302 may be tested or verified using testing dataset 312. The machine learning model 302 may be tested for accuracy, speed, and other parameters such as the number of false negative or false positive results, as required to qualify machine learning model 302 for use on production data 316. Once qualified, production data 316 may be input to the model 314, which implements machine learning model 302, to produce prediction results 318.

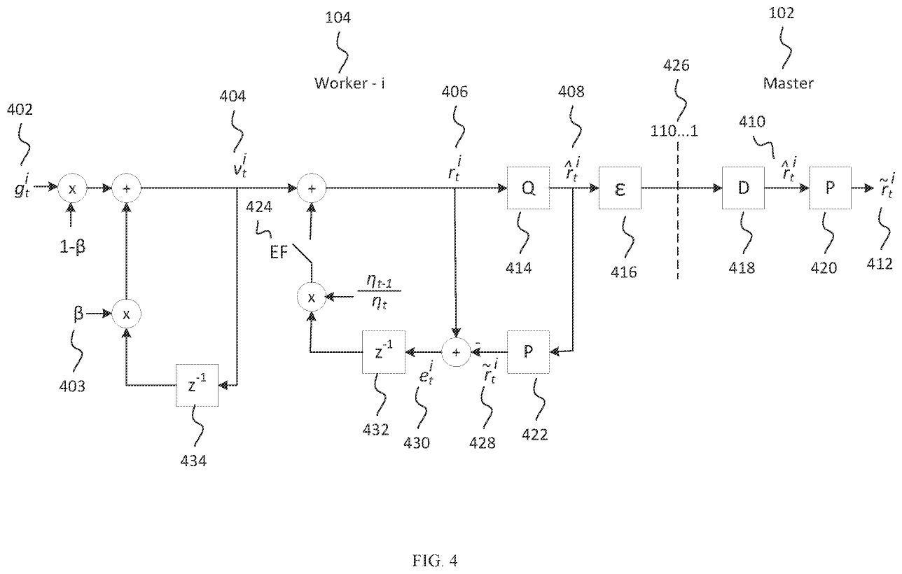

With reference to FIG. 4, embodiments compress update vectors between two computer nodes, such as master 102 and any of workers 104, by communicating a subset of elements of the update vectors. In embodiments, parts of elements, for example, only the most significant elements may be included in the subset, with most significant being determined using a criteria such as the absolute value of each vector element. Elements that are not communicated are predicted, or estimated, at the computer node receiving the update and may also be predicted by the sending computer node. For example, a worker 104 may transmit the most significant elements of an update vector to the master 102. The master 102 receives the most significant elements and predicts the remaining elements that were not communicated by taking advantage of the temporal correlation between vector elements of prior values of the same vector element previously received or predicted. Similarly, the sending worker 104 may predict the remaining elements that were not communicated using the same prediction method as the master 102 allowing both the sending worker 104 and the receiving master 102 to obtain the same reconstructed vector data.

With reference to FIG. 4, in embodiments, gₜⁱ is a stochastic gradient calculated by a worker 104 where i indicates the worker that calculated the stochastic gradient vector and t indicates the iteration (time) of the time series of the vector. For example, g₅² would refer to the vector, g, calculated by worker 2 (reference 104b in FIG. 1) at time=5.

Parameter β 403, 0≤β<1, is used to control the low pass filter effects of the momentum-SGD algorithm and in practice may be set close to 1. In embodiments, this may be 0.9 or 0.99. The gradient vector, gₜⁱ 402, is used to produce update vector, vₜⁱ 404, where vₜⁱ=βvₜ₋₁ⁱ+(1−β)gₜⁱ. Using a value of β close to 1 ensures that values of vₜⁱ are determined mainly by the previous value of v, that is vₜ₋₁ⁱ.

In embodiments, switch EF 424 may be open and vector rₜⁱ=vₜⁱ. In embodiments with error feedback, switch EF 424 is closed and vector

$${r}_{t}^{i} = {v}_{t}^{i} + \frac{{η}_{t - 1}}{{η}_{t}} {e}_{t - 1}^{i} ,$$

where nₜ is a learning rate, and eₜⁱ is an error vector, indicating a difference between the vector, rₜⁱ 406, and the reconstructed or predicted vector, \tilde{r}ₜⁱ 428.

In embodiments, a quantizer, Q 414, is used to compress the vector, rₜⁱ 406, to produce a sparse vector, \hat{r}ₜⁱ 408. Vector \hat{r}ₜⁱ 408 is given by the equation \hat{r}ₜⁱ=Q(rₜⁱ). In embodiments, the Q 414 operator produces sparse vector, \hat{r}ₜⁱ 408, by setting all elements in vector rₜⁱ 406 to zero except for the K elements with the largest absolute value magnitudes. Alternatively, other quantizers may be used that select or omit vector elements based on other criteria.

In embodiments, encoder, ε 416, is used to produce a bit stream 426 that is transmitted to the master 102 by encoding the non-zero locations in \hat{r}ₜⁱ 408 and the corresponding values.

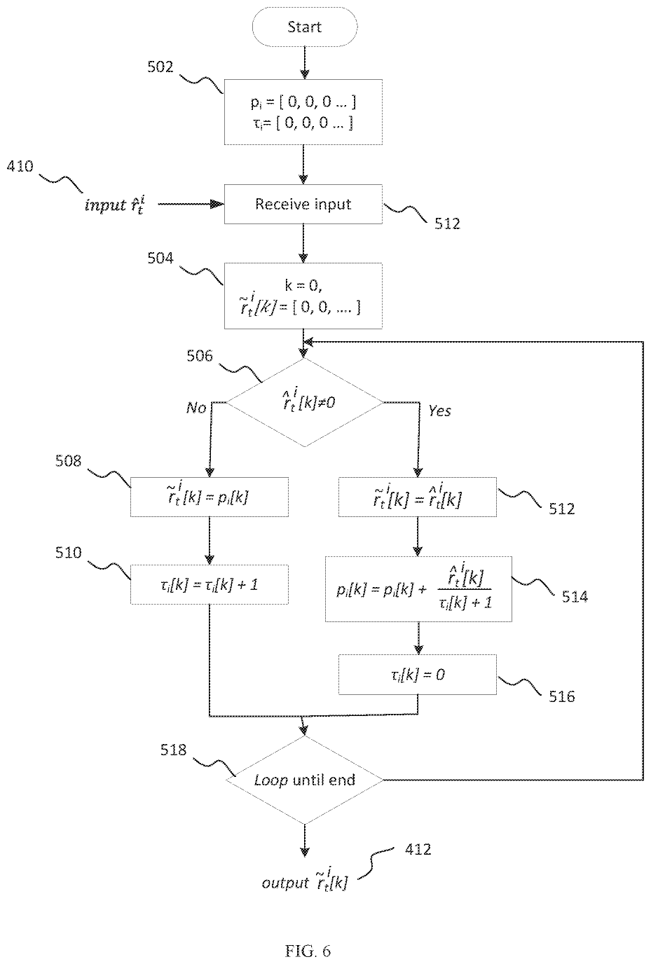

Master 102 received bitstream 426 at decoder, D 418 and recreates the sparse vector, \hat{r}ₜⁱ 410, that was transmitted by worker 104. A prediction system, P 420, may then be used to predict one of more of the zero value elements of vector, rₜⁱ 406 that were not included in sparse vector, \hat{r}ₜⁱ 410, and not included in received bitstream 426. Predicted vector elements may be used to create a reconstructed vector, \tilde{r}ₜⁱ, using the equation \tilde{r}ₜⁱ=P(\hat{r}ₜⁱ), and are combined with received vector elements to produce vector \tilde{r}ₜⁱ. An example of a prediction method is illustrated in FIG. 6 and described below.

In embodiments, worker node 104 may also use its own prediction system, P 422, to apply the same predicted vector elements to the sparse vector to obtain a vector \tilde{r}ₜⁱ 428, that is the same vector \tilde{r}ₜⁱ 412 as used by master 102.

In embodiments, workers 104a through 104h may calculate stochastic gradient vectors, gₜ¹, gₜ², . . . , gₜⁿ, where in the example of FIG. 1, n=8, and transmit updates vectors, vₜ¹, vₜ², . . . , vₜⁿ, to master 102. The master then computes an average of \tilde{r}ₜⁱ across all workers (all i). Finally, master 102 broadcasts the average back to the workers 104. All workers 104 then update their parameter vector,

$${w}_{t + 1} = {w}_{t} - {η}_{t} \frac{1}{n} {\sum }_{i ∈ [ n ]} {\tilde{r}}_{t}^{i} ,$$

used in training the machine learning model.

Though the embodiment of FIG. 4 is described from the point of view of a worker 104 transmitting an update vector 404 to a master 102, the same method may also be applied to a master 104 transmitting an update vector 404 to any of a plurality of workers 104. More generally, the method of FIG. 4 may be used to transmit any suitable vector data from one computer node to another computer node.

In embodiments, the number of elements in the vectors will vary depending on the application and the value of K may also be varied to obtain a compression factor that yields acceptable results.

As shall be appreciated on a more generic level, quantizer 414 may be any compression method that may be used on a time correlated series of vector data. Furthermore, the prediction systems 420 and 422 may include any number of methods, designed jointly with quantizer 414, in order to produce a more efficiently compressed bit stream 426, consisting of fewer bits. The decoder 418 and prediction system 420 can act on the bit stream 426 to produce the predicted vector 412.

Referring again to FIG. 4, embodiments may use error-feedback where a switch EF 424 is in the closed position to feedback the error between the update vector, rₜⁱ 406, and the predicted vector, \tilde{r}ₜⁱ 412, as received by the master 102. Predictor, P 422, operates on the sparse vector, \hat{r}ₜⁱ 408, to create an error vector with predicted values, \tilde{r}ₜⁱ 428, which has identical values to predicted vector, \tilde{r}ₜⁱ 412, calculated by the master 102. Vector 428 is subtracted from update vector, rₜⁱ 406 to produce error vector, eₜⁱ 430, where eₜⁱ=rₜⁱ−\tilde{r}ₜⁱ 430, may then be combined with update vector, vₜⁱ 404. In embodiments, both functions, z⁻¹ 432 and 434, may be unit delays.

In embodiments, predictors, P 422 at worker 104 and P 420 at master 102, may be used to predict or estimate any of the vector elements that are not in the top K most significant elements. Since both computer nodes, master 102 and worker 104, use the same predictor, both sides have access to the same data.

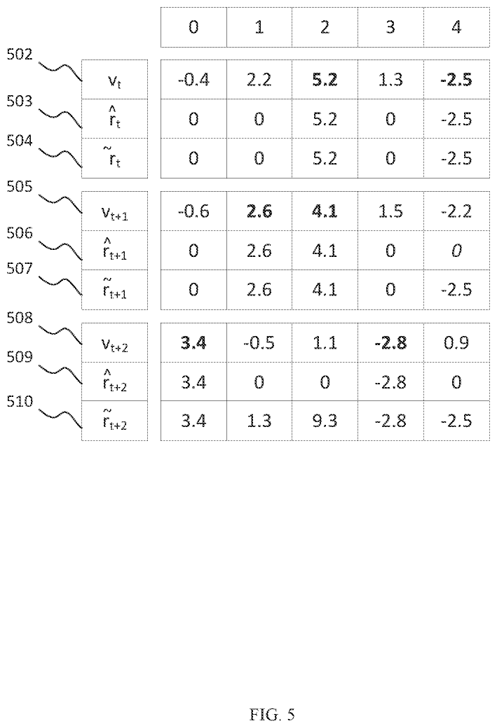

The operation of encoder 416 is illustrated in FIG. 5 according to an embodiment. In this non limiting example, vₜ, vₜ₊₁, and vₜ₊₂, are consecutive update vectors with five elements, numbered 0, 1, . . . , 4. Quantizer, Q 414, operates on vₜ, vₜ₊₁, and vₜ₊₂ to produce corresponding sparse vectors, \hat{r}ₜ, \hat{r}ₜ₊₁, and \hat{r}₊₂. The value K in this example is 2. At time t, vₜ₌₍₋0.4, 2.2, 5.2, 1.3, −2.5) 502. The two elements with the largest absolute value magnitude are element 2, 5.2, and element 4, −2.5. Therefore, sparse vector \hat{r}ₜ=(0, 0, 5.2, 0, −2.5) 503 since the K largest values are passed through while all other values are set to zero. Similarly, at time t+1, vₜ₊₁=(−0.6, 2.6, 4.1,1.5, −2.2) 505. The two elements with the largest absolute value magnitude are element 3, 4.1, and element 2, 2.6. Therefore, sparse vector \hat{r}ₜ₊₁=(0,2.6, 4.1,0,0) 506 since the K largest values are passed through while all other elements are set to zero. Similarly, at time t+2, vₜ₊₂=(3.4, −0.5, 1.1, −2.8, 0.9) 508. The two elements with the largest absolute value magnitude are element 0, 3.4, and element 3, −2.8. Therefore, sparse vector \hat{r}ₜ₊₂=(0,2.6,4.1,0,0) 509 since the K largest values are passed through while all other elements are set to zero.

FIG. 6 illustrates a method that may be used by predictors, P, according to an embodiment. Predictors include memory to allow for the storage of predicted values, ρᵢ, and a counter, τᵢ, a vector that indicates the number of times an estimated value was used for a vector element of \tilde{r}ₜⁱ. Initially, t=0, in step 502, the state vectors, ρᵢ, and counter, τᵢ are initialized with all elements set to zero, i.e., ρᵢ=0 and τᵢ=0. In step 512, a sparse vector input, \hat{r}ₜⁱ 408 or 410, is received. Predicted vector \tilde{r}ₜⁱ 412 is stored locally after having first been initialized to zero for each element. Each element, k, of the of \tilde{r}ₜⁱ 412 is processed. In step 506, a check is made of \hat{r}ₜⁱ[k] to determine if a zero value or no value has been received, i.e., is \hat{r}ₜⁱ[k]≠0. If there is no value or a zero value of \hat{r}ₜⁱ [k] then, in step 508, a predicted value, ρᵢ[k], is assigned to \tilde{r}ₜⁱ[k], and in step 510 the counter, τᵢ[k], is incremented by 1 to indicate that no value had been received for \hat{r}ₜⁱ[k] at time t. If a value for \hat{r}ₜⁱ[k] has been received then, in step 512, that value is used in the predicted vector, \tilde{r}ₜⁱ[k]=\hat{r}ₜⁱ[k]. In step 514, the estimated value, ρᵢ[k], is updated for future use using the formula,

$${p}_{i} [ k ] = {p}_{i} [ k ] + \frac{{\hat{r}}_{t}^{i} [ k ]}{{τ}_{i} [ k ] + 1} ,$$

and in step 516, the counter, τᵢ[k], is reset to zero. In step 518, the next vector element is analyzed until all vector elements have been processed and a complete predicted vector, \tilde{r}ₜⁱ, is produced.

With reference to FIG. 5, at time t, the vector elements of vₜ 502 not included in sparse vector sparse vector, \hat{r}ₜ 503, are elements 0, 1, and 3. These elements are predicted by predictors 420, or 422, or both 420 and 422 as described above, using an algorithm such as the predictor method of FIG. 6. At time t, both the stored predicted values, τᵢ, and the counter, τᵢ, have values of zero so the predicted values are also zero and the predicted vector, \tilde{r}ₜⁱ 504, are equal to the sparse vector, \hat{r}ₜ 503. At time t+1, vector element 4 is not part of sparse vector, \hat{r}ₜ 506, however since a value for element 4 of sparse vector 503 was received at time t, element 4 may be predicted to yield a value of −2.5, based on the time correlation of consecutive sparse vectors 503 and 506. Finally, at time t+2, vector elements 1, 2, and 4 are not part of sparse vector, \hat{r}ₜ 509, however since values for these elements were received previously, they may be predicted to yield values of 1.3, 9.3, and −2.5, based on the time correlation of consecutive sparse vectors 503, 506 and 510.

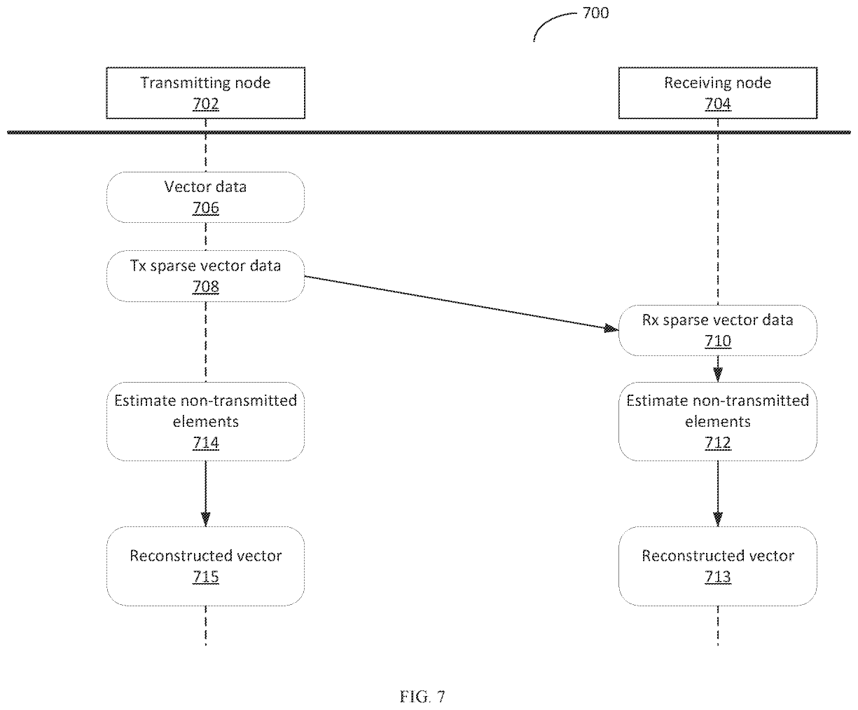

FIG. 7 illustrates a generalized method 700 for transmitting vector data between computer nodes, such as from a transmitting node 702 to a receiving node 704, according to an embodiment. Transmitting computer node 702 obtains vector data 706 including a plurality of vector elements. Vector data 706 may be obtained by a momentum-SGD method where variations in vector elements over time have minimal changes between iterations or that consecutive vector elements are sufficiently correlated in time. The transmitting node 702 and the receiving node 704 communicate or are configured with a criteria, such as a value, K, which indicates the number of most significant vector elements of vector data 706 are to be transmitted. Transmitting node 702 selects the K-th most significant vector elements from vector data 706 to create Tx sparse vector data 708. Tx sparse vector data 708 includes K vector elements with the remaining vector elements set to zero. Tx sparse vector data 708 may be encoded for transmission using a variety of methods including transmitting their position within vector data 706 and their value. Once encoded, the transmitting node 702 transmits the encoded sparse vector data 708 over a communications link to receiving node 704. Receiving node 704 decodes the encoded sparse vector data 708 to obtain Rx sparse vector data 710 which includes the K most significant elements of vector data 706. Independently, receiving node 704 or both receiving node 704 and transmitting node 702 make estimations of the non-transmitted elements 712 and 714 of vector data 706. In embodiments, the estimation of non-transmitted elements may use methods that utilize the time correlation of vector elements between consecutive vectors, such as the method of FIG. 6. Transmitting node 702 obtains reconstructed vector 715 and receiving node 704 obtains reconstructed vector 713. Both reconstructed vectors 713 and 715 include the K most significant vector elements of vector data 702 combined with estimations of the non-transmitted elements independent calculated by receiving node 704 and transmitting node 702.

In accordance with embodiments of the present disclosure, there is provided a method of communicating time correlated vector data within a network. The method includes reading, by a transmitting node, a first vector data including a plurality of elements. The transmitting node selects a subset of elements of the plurality of elements based on a criteria and sends the subset of elements to a receiving node. A receiving node receives the subset of elements and estimates a plurality of elements not included in the subset of elements based on a previously received subset of element based on a second vector data. The first vector data and the second vector data are part of a time series of vectors.

In a further embodiment, the estimating the plurality of elements not included in the subset of elements includes updating, when one of the subset of elements is received, a predicted value of the one of the subset of elements and clearing a counter, and setting, when one of the subset of elements is not received, one of the plurality of elements not included in the subset of elements with the predicted value, and incrementing the counter.

In a further embodiment, the criteria is an absolute value of each of the plurality of elements of the first vector data.

In a further embodiment, the first vector data and the second vector data are update vectors as part of a machine learning model training process.

Further embodiments include estimating, by the transmitting node, the plurality of elements not included in the subset of elements based on the previously received subset of element based on the second vector data. The transmitting node forms a reconstructed vector data including the subset of elements and the estimated plurality of elements not included in the subset of elements.

In a further embodiment, the first vector data is obtained by combining an initial vector data with a weighted difference of the reconstructed vector data and the first vector data.

In accordance with embodiments of the present disclosure, there is provided a network node for transmitting vector data over a network connection. The network node includes a processor and a non-transient memory for storing instructions which when executed by the processor cause the network node to read a first vector data including a plurality of elements, select a subset of elements of the plurality of elements based on a criteria, and send the subset of elements to a receiving node. The instructions further cause the network node to estimate a plurality of elements not included in the subset of elements based on a previously transmitted subset of elements based on a second vector data, and form a reconstructed vector data including the subset of elements and the estimated plurality of elements not included in the subset of elements.

In a further embodiment, the estimating the plurality of elements not included in the subset of elements includes updating, when one of the subset of elements is received, a predicted value of the one of the subset of elements and clearing a counter, and setting, when one of the subset of elements is not received, one of the plurality of elements not included in the subset of elements with the predicted value, and incrementing the counter.

In further embodiments, the criteria is an absolute value of each of the plurality of elements of the first vector data.

In further embodiments, the first vector data and the second vector data are update vectors as part of a machine learning model training process.

In further embodiments, the first vector data is obtained by combining an initial vector data with a weighted difference of the reconstructed vector data and the first vector data.

In accordance with embodiments of the present disclosure, there is provided a network node for receiving vector data over a network connection. The network node includes a processor and a non-transient memory for storing instructions which when executed by the processor cause the network node to receive, from a transmitting node, a subset of elements of a first vector data and estimating a plurality of elements not included in the subset of elements based on a previously received subset of element based on a second vector data. The first vector data and the second vector data are part of a time series of vectors and the subset of elements selected by the transmitting node is based on a criteria. The receiving node also forms a reconstructed vector data including the subset of elements and the estimated plurality of elements not included in the subset of elements.

In further embodiments, the estimating the plurality of elements not included in the subset of elements includes updating, when one of the subset of elements is received, a predicted value of the one of the subset of elements and clearing a counter, and setting, when one of the subset of elements is not received, one of the plurality of elements not included in the subset of elements with the predicted value, and incrementing the counter.

In further embodiments, the criteria is an absolute value of each of the plurality of elements of the first vector data.

In further embodiments, the first vector data and the second vector data are update vectors as part of a machine learning model training process.

In further embodiments, the first vector data is obtained by combining an initial vector data with a weighted difference of the reconstructed vector data and the first vector data.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present disclosure may be implemented by using hardware or by using software and a necessary universal hardware platform. Based on such understandings, the technical solution of the present disclosure may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present disclosure. For example, such an execution may correspond to a simulation of the logical operations as described herein. The software product may additionally or alternatively include number of instructions that enable a computer device to execute operations for configuring or programming a digital logic apparatus in accordance with embodiments of the present disclosure.

It will be appreciated that, although specific embodiments of the technology have been described herein for purposes of illustration, various modifications may be made without departing from the scope of the technology. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

1. A method of communicating vector data within a network, the method comprising:
obtaining, by a transmitting node, a first vector data including a plurality of elements;
selecting, by the transmitting node, a subset of elements of the plurality of elements;
sending, by the transmitting node, the subset of elements to a receiving node;
estimating, by the transmitting node, a plurality of elements not included in the subset of elements based on a previously transmitted subset of element; and
forming, by the transmitting node, a reconstructed vector data including the subset of elements and the estimated plurality of elements not included in the subset of elements.

2. The method of claim 1 wherein the estimating the plurality of elements not included in the subset of elements comprises:
updating, when one of the subset of elements is transmitted, a predicted value of the one of the subset of elements and resetting a counter; and
setting, when one of the subset of elements is not transmitted, one of the plurality of elements not included in the subset of elements with the predicted value, and incrementing the counter.

3. The method of claim 1 wherein the subset of elements is selected based on a criteria, and the criteria is an absolute value of each of the plurality of elements of the first vector data.

4. The method claim 1 wherein the estimating is further based on a second vector data, and the first vector data and the second vector data are update vectors as part of a machine learning model training process.

5. The method of claim 1 wherein, the first vector data and the second vector data being part of a time series of vectors.

6. The method of claim 1 wherein the first vector data is obtained by combining an initial vector data with a weighted difference of the reconstructed vector data and the first vector data.

7. The method of claim 2 wherein the subset of elements is selected based on a criteria, and the criteria is an absolute value of each of the plurality of elements of the first vector data.

8. The method claim 2 wherein the estimating is further based on a second vector data, and the first vector data and the second vector data are update vectors as part of a machine learning model training process.

9. A network node for transmitting vector data over a network connection, the network node comprising:
a processor and a non-transient memory for storing instructions which when executed by the processor cause the network node to:
obtain a first vector data including a plurality of elements;
select a subset of elements of the plurality of elements;
send the subset of elements to a receiving node; and
estimate a plurality of elements not included in the subset of elements based on a previously transmitted subset of elements; and
forming a reconstructed vector data including the subset of elements and the estimated plurality of elements not included in the subset of elements.

10. The network node of claim 9 wherein the estimating the plurality of elements not included in the subset of elements comprises:
updating, when one of the subset of elements is transmitted, a predicted value of the one of the subset of elements and resetting a counter; and
setting, when one of the subset of elements is not transmitted, one of the plurality of elements not included in the subset of elements with the predicted value, and incrementing the counter.

11. The network node of claim 9 wherein the subset of elements is selected based on a criteria, and the criteria is an absolute value of each of the plurality of elements of the first vector data.

12. The network node claim 9 wherein the estimating is further based on a second vector data, and the first vector data and the second vector data are update vectors as part of a machine learning model training process.

13. The network node of claim 9 wherein the first vector data is obtained by combining an initial vector data with a weighted difference of the reconstructed vector data and the first vector data.

14. The network node of claim 9 wherein the first vector data is obtained by combining an initial vector data with a weighted difference of the reconstructed vector data and the first vector data.

15. The network node of claim 10 wherein the subset of elements is selected based on a criteria, and the criteria is an absolute value of each of the plurality of elements of the first vector data.

16. A network node for receiving vector data over a network connection, the network node comprising:
a processor and a non-transient memory for storing instructions which when executed by the processor cause the network node to:
receive, from a transmitting node, a subset of elements of a first vector data;
estimate a plurality of elements not included in the subset of elements based on a previously received subset of element based on a second vector data, the first vector data and the second vector data being part of a time series of vectors, the subset of elements selected by the transmitting node; and
form a reconstructed vector data including the subset of elements and the estimated plurality of elements not included in the subset of elements.

17. The network node of claim 16 wherein the estimating the plurality of elements not included in the subset of elements comprises:
updating, when one of the subset of elements is received, a predicted value of the one of the subset of elements and resetting a counter; and
setting, when one of the subset of elements is not received, one of the plurality of elements not included in the subset of elements with the predicted value, and incrementing the counter.

18. The network node of claim 16 wherein the subset of elements is selected based on a criteria, and the criteria is an absolute value of each of the plurality of elements of the first vector data.

19. The network node claim 16 wherein the first vector data and the second vector data are update vectors as part of a machine learning model training process.

20. The network node of claim 16 wherein the first vector data is obtained by combining an initial vector data with a weighted difference of the reconstructed vector data and the first vector data.
